(19) United States
(12) Patent Application Publication
(10) Pub. No.: US 2024/0295086 A1
(43) Pub. Date: Sep. 5, 2024

(54) METHOD OF ACCURATELY MEASURING THE TOPOGRAPHY OF SURFACES IN CIVIL ENGINEERING AND A DEVICE FOR CARRYING OUT THIS METHOD

(71) Applicant: Exact Control System a.s., Praha (CZ)

(72) Inventors: Vitezslav OBR, Trebic (CZ); Marek PRIKRYL, Velka Chuchle (CZ); Petr POKORNY, Tehov (CZ); Stepan HODIK, Dusniky (CZ)

(21) Appl. No.: 18/572,468

(22) PCT Filed: Jun. 21, 2022
(86) PCT No.: PCT/CZ2022/000030

§ 371 Date: Dec. 20, 2023

(30) Foreign Application Priority Data
Jul. 1, 2021 (CZ) PUV2021-38955

(51) Int. Cl. E01C 23/01; G01C 15/00; G01S 17/42; G01S 17/86; G01S 19/48

(52) U.S. Cl. CPC E01C 23/01; G01C 15/002; G01S 17/42; G01S 17/86; G01S 19/485

(57) ABSTRACT

The invention relates to a method for accurately measuring the topography of surfaces in civil engineering, wherein a scanning vehicle (B1) and a measuring vehicle (A1) are used, wherein the measurement is carried out in n repeating measurement cycles, wherein the n cycles comprise a measurement section, wherein one measurement cycle is carried out by, the scanning vehicle (B1) equipped with a GNSS receiver and a laser scanner (B3) stands at the beginning of the measurement section of the measured area and the measuring vehicle (A1) equipped with a GNSS receiver (A4) and a total station (A3) stands on the target area in front of the scanning vehicle (B1) at a distance of 20 to 250 metres, when the spatial position of the laser scanner (B3) and/or the total station (A3) changes, their spatial positions are determined by the GNSS receiver, then the aiming vehicle (A1) is used by the total station (A3) to aim back to the target device (B6), which marks the initial turning point of the measuring cycle, and the scanning vehicle (B1) scans to determine the topography of the measured area, the scanning vehicle (B1) then traverses the scanning vehicle (B1) in successive steps at intervals of 10 to 500 metres between scanning positions, while the scanning vehicle (B1) traverses between scanning positions, the target device (B6) and the total station (A3) measure registration points on the surface of the measured area at maximum intervals of 125 metres, this process being repeated until the scanning vehicle (B1) overtakes the measuring vehicle (A1) by a distance of 20 to 250 metres, where the total station (A3) makes a foresight at the target device (B6) which marks the final turning point of the measuring cycle, after which the measuring vehicle (A1) moves to the next station which is in front of the scanning vehicle (B1) at a distance of 20 to 250 m and thus one measuring cycle is completed and the measuring cycle is repeated with the next cycle starting with the backsight at the final turning point from the previous measuring cycle, and repeating the measuring cycles until the entire measuring assembly has reached the end of the section of the area to be measured. Further, the invention relates to a device for high-precision measurement of surface topography in civil engineering comprising a vehicle equipped with measuring instruments and accessories, the vehicle comprising two ground vehicles, the first of which Is a measuring vehicle (A1) with an exposed load compartment, on the hull of which a carrier platform (A2) provided with a mechanism for vertical movement thereof is arranged, and on the carrier platform (A2) a total station (A3) and a first GNSS receiver (A4) are arranged, the centre of which lies in the rotational axis of the total station (A3), and where the second ground vehicle is a scanning vehicle (B1) having a roof mount (B2), to which is attached a laser scanner (B3) above which is a reflecting device (B5) for an electro-optical rangefinder and a second GNSS receiver (B4) in its vertical axis, and furthermore a means (B6) for locating reference points on the measured area, equipped with a reflecting device, is attached to the scanning vehicle (B1), wherein the measuring vehicle (A1) comprises a first control unit (A7) equipped with a program for controlling the components on the measuring vehicle and for continuously checking the measured values against predetermined accuracy criteria, wherein this first control unit (A7) is connected to the output of the first GNSS receiver (A4) and further connected bidirectionally to the total station (A3) and the scanning car (B1) comprises a second control unit (B7) equipped with a program for controlling the individual measuring instruments and for continuously checking the measured values in relation to predetermined accuracy criteria, wherein the second control unit (B7) is connected to the output of the second GNSS receiver (B4) and is further connected bidirectionally to the laser scanner (B3), and at the same time the first control unit (A7) and the second control unit (B7) are connected by their outputs.

### TECHNICAL FIELD

The invention relates to a method of accurately measuring the topography of surfaces in civil engineering and to a device for carrying out the method, wherein ground transport means equipped with measuring instruments and accessories are used to determine the topography of the surface to be surveyed. The solution describes the measurement and processing of data of the topography of the surface of the structural layers of roads and other transport communications in civil engineering for the purpose of their analysis or repair.

### BACKGROUND ART

The inventors are not aware of a technical solution to measure and process surface topography data of road construction layers, airport surfaces, hall floors, earth bodies and other paved surfaces with guaranteed equal surface height accuracy characterised by a height standard deviation of 6 mm/km or better with respect to the height coordinate system of the structure and with an average point density of 2000 points/m² or higher.

In general, contact measuring instruments are most often used for determining geometric parameters, where the measuring operator ensures direct contact of the measuring instrument with the object to be measured. Most often this involves total station tachymetric measurements or GNSS receiver measurements. When surveying the terrain with these instruments, a grid of points is chosen, e.g. in 20 to 30 m intervals or points in 5 to 10 m sections, and does not reach the density of a digital terrain model of 1000 points/m² or higher. These are selective methods that are subjectively dependent on the operator of the measurement, have insufficient density of measured points for a detailed representation of the object of measurement and the accuracy of the measurement on unpaved terrain may be affected by the sticking of the tip of the rod, i.e. its lower end, into the surface of the measured object. Due to the selective selection of points, the measurement cannot be verified after the structural layer has been covered. These methods do not eliminate the influence of operator error and are therefore subjective.

Heights can also be determined in combination with the above contact measuring instruments by the method of precision or very precise levelling using precision levelling instruments. These methods have a high accuracy of height determination down to sub-millimetre accuracy. The use of precision and very precise levelling methods in combination with total station or GNSS receiver measurements is time consuming, requiring the stabilisation of detailed points to be measured in two stages, once for position and twice for height. It is only usable on paved terrain while ensuring that disturbances are limited, for example ensuring traffic is restricted by obstructions when the road is in use.

Nowadays, these contact methods are being replaced by non-contact methods, consisting of indirect contact of the measuring instrument with the object to be measured. Laser scanning technology most often belongs to this group. A laser scanner is an active sensor that emits laser beams. During the measurement, the scanner is static at one place, static method or also stop & go, or the scanner moves during the measurement and it is mobile scanning. These methods are non-contact, have a high density of measurement points, and are a non-selective measurement method where the detailed measurement points are not selected by the measurement operator.

When measuring in motion, the measured data are related to the position of the measurement trajectory and the inclinations of the measuring system. The position of the measurement trajectory is determined from the GNSS receiver and refined by the inertial unit. The inertial unit with odometer also records the roll and pitch of the measuring system. The method is fast, but does not achieve an elevation standard deviation of 2 mm to 5 mm with respect to the elevation coordinate system at any location of the measured object. The measurement does not have the same accuracy of output at each location of the measured object. Thus, repeating a measurement will not produce the same result. An example of such a technical solution is described in patent Z document GB 2 434 269. It is not known that the described device has been used to obtain absolute detailed digital object models of buildings and road reconstructions with a guaranteed equal surface height accuracy characterised by a height standard deviation of 6 mm/km with respect to the building height coordinate system at any location of the measured object.

During stationary measuring, data is collected from the so-called scan position, i.e. the measured data is related to the position, orientation and tilt of the scanner. The position, orientation and tilt of the scanner, collectively the registration of the scan position, is determined either by a direct method or by one of three indirect methods: registration using natural identical points, registration using cloud correlation, registration using similarity of geometric shapes. For a description of such a technical solution, see for example document ITMO20110313 (A1). This technical solution does not achieve an accuracy of 6 mm/km standard deviation with respect to the building coordinate system.

Both methods of registration of the scan position require direct or indirect combination with other geodetic methods such as GNSS measurements, total station tachymetry, level measurements, laser scanning, compass measurements, inclinometer measurements, etc. The procedure is lengthy and the correct combination of methods must be used to guarantee the same accuracy of the output with respect to the height coordinate system at each location of the object to be measured. However, combining methods is time-consuming and measurements take place at different times due to the different speeds of the measurement methods and thus often in different atmospheric conditions. In refinement, using the contact method, the direct presence of the measurement operator on the road is necessary. This makes safety precautions necessary when taking measurements on an open road. This is also very demanding both in terms of organisation and time.

From document EP 3 169 972 B1 is known a device using a measurement method combining static laser scanning with a robotic levelling method, which is described e.g. in Olav Vestol et al: “Reports in Geodesy and Geographical Information Systems; Review of current and near-future levelling technology—a study project within the NKG working group of Geoid and Height Systems” (hereafter referred to as “Vestol”) discloses motorised levelling. This device uses three measuring vehicles which move in successive steps as a unit along the object to be measured, for example a road, maintaining approximately equal spacing. This technical solution guarantees a high height accuracy characterised by a standard deviation of 2 mm to 5 mm. The disadvantage of this solution is that it requires at least 3 operators, 3 vehicles and 3 measuring devices. The patent contains a solution for very accurate topography measurement by means of vehicles equipped with measuring devices, which are in particular a laser scanner and a levelling device. The assembly of the transport means includes a middle, an end and a front transport means. The centre vehicle is designed to collect detailed points, the front vehicle is designed for forward intent and the rear vehicle is designed for reverse intent and contains target devices for measuring the heights of identical points.

### SUMMARY OF INVENTION

The above-mentioned shortcomings are eliminated by a method of accurately measuring the topography of surfaces in civil engineering, whereby ground vehicles equipped with measuring instruments and accessories are used and the topography of the surface to be surveyed is determined, according to the present invention. Its essence is that two means of transport, namely a scanning means of transport and a measuring means of transport, are used, the measurement being carried out in n repeating measuring cycles, where n cycles form a measuring section, where one measuring cycle is carried out in such a way that the scanning means of transport equipped with a GNSS receiver and a laser scanner stands at the beginning of the measuring section of the surveyed area and the measuring means of transport equipped with a GNSS receiver and a total station stands on this surveyed area in front of the scanning means of transport at a distance of 20 to 250 metres. When the spatial position of the laser scanner and/or total station changes, their spatial positions are determined by the GNSS receiver. Next, from the measuring means of transport, the total station aims backsight at the target device, which marks the initial turning point of the measuring cycle, and the scanning means of transport performs a scan to determine the topography of the measured area. The scanning vehicle then travels in repeated steps with scan position spacing of 10 to 500 meters, and during the scanning vehicle's traverse between scan positions, the target device and total station measure registration points on the surface of the measured area at maximum spacing of 125 meters. This procedure is repeated until the scanning vehicle overtakes the measuring vehicle by a distance of 20 to 250 metres, where the total station makes a foresight at the target device, which marks the final turning point of the measuring cycle. After this step, the measuring vehicle moves to the next station which is in front of the scanning vehicle at a distance of 20 to 250 m, and thus the whole of one measuring cycle is completed and the measuring cycle is repeated, the next cycle starting with the backsight of the final turning point from the previous measuring cycle, and the measuring cycles are repeated until the whole measuring assembly reaches the end of the measured section of the measured area.

The measured section is preferably closed at the initial turning point of the first measuring cycle of the measured section so that, by moving the measuring vehicle between 20 and 250 metres from the final turning point of the last measuring cycle of the measured section back towards the start of the measured section and repeating the whole procedure until the initial turning point of the first measuring cycle of the measured section is measured to close the whole measuring procedure at the same point and to evaluate the quality of the measurement, in particular by evaluating the height closure, and to ensure a higher density of scanning and registration points.

When closing the measured section in a sequence of n cycles, it is preferably performed without scanning the surface of the measured area and/or measuring the registration points.

The output of these measurements are registration points and turning points, which are used for height refinement of the scanned surface measurement of the measured area that was performed by the scanner. The turning points may be stabilised by measuring nails or other similar stabilisation.

The coordinates of the individual scan positions can be determined by GNSS receiver measurements and/or total station orientation from the measuring vehicle.

In addition to the registration points and the turning points, the total station may measure points of the point field from the measuring vehicle for the purposes of accuracy checking, measurement alignment and transformation into coordinate systems other than the coordinate system in which the measurement is made.

At least one turning point may be replaced by a point of the point field and the foresight and backsight to that replaced turning point shall be replaced by a foresight and backsight to that point of the point field.

The scanning of the surface of the measured area by the scanner may take place during the travel of the scanning vehicle between the measurement points of the initial turning point and the end turning point of the measurement cycle. Another essence of the invention is a device for high-precision measurement of surface topography in civil engineering comprising a transport means equipped with measuring instruments and accessories. The essence of the new solution is that it comprises two ground vehicles, the first of which is a measuring vehicle on which is placed a supporting platform provided with a mechanism for its vertical movement. The carrier platform carries a total station and a first GNSS receiver, the centre of which lies in the rotational axis of the total station. The second ground vehicle is a scanning vehicle which is provided with a mount to which a laser scanner is attached. Above the laser scanner is a reflective device for an electro-optical rangefinder and/or a second GNSS receiver in its vertical axis. The scanning vehicle shall include a target device used to locate registration points on the target area equipped with a reflecting device. The measuring vehicle includes a first control unit equipped with a program for controlling the components on the measuring vehicle and continuously checking the measured values in relation to predetermined accuracy criteria. This first control unit is connected to the output of the first GNSS receiver and is further connected bidirectionally to the total station. The scanning conveyor means includes a second control unit equipped with a program for controlling the individual measuring instruments and for continuously checking the measured values in relation to predetermined accuracy criteria. This second control unit is connected to the output of the second GNSS receiver and is further connected bidirectionally to the laser scanner. At the same time, the first and second control unit are linked by their outputs.

The purpose of the present solution is to overcome the aforementioned shortcomings of the described methods and measuring devices, their use and result generation by using a fast, accurate, safe, more compact and surface-representing measuring device, with which a area measurements can be created according to this solution. Minimise the subjective influence of a measurer, the effect of temperature and pressure on the measured quantities e.g. angles and lengths.

The benefit of this invention is that it increases the safety of the measurers by not forcing them to leave the safety of the vehicle. The device performs a series of automated checks, thereby eliminating errors that would only become apparent in post-processing and would increase the cost of the measurement by having to pay for the entire measurement including associated costs such as road closure. Furthermore, this device reduces the cost of the measurement itself, as it automates many steps that would have to be done manually, while maintaining the speed of the measurement even in a multi-person team. Last but not least, this device increases the comfort of the measurers, who do not have to physically strain to carry the equipment and perform a sequence of tasks in an often stressful environment. It is also important that such automated device can be operated by a less skilled worker, which solves the problem of the lack of experienced workers in the field.

The present invention also differs from the existing known technical solutions in that it uses only one total station, only two cars and is possibly supplemented by several GNSS receivers, during the measurement it performs control calculations of the achieved accuracy for immediate detection of the measurement error, automatic calculation and optimization of the measured values immediately after the completion of the measurement of the object, it is usable even by less qualified operators.

Compared to the EP 3 169 972 B1, the above-mentioned device for high-precision measurement of surface topography in civil engineering is characterised by the fact that it contains two vehicles instead of three. It also differs in that instead of a levelling device and levelling bars, the heights of the insertion points and scanner are determined trigonometrically using a total station. The advantages of such a solution are mainly the increase in measurement speed due to the technology used, its cheaper cost, which consists in the reduction of the number of vehicles and personnel, and the possibility of position measurement even in places where GNSS signals cannot be received, such as a tunnel.

### BRIEF DESCRIPTION OF DRAWINGS

The device for high-precision measurement of surface topography in civil engineering according to the submitted solution will be further described by means of the attached drawings.

FIG. 1 shows a diagram of the measuring vehicle and

FIG. 2 shows a diagram of the scanning vehicle.

FIG. 3 shows schematically the interconnection of the control units of the transport means with each other and with the individual instruments.

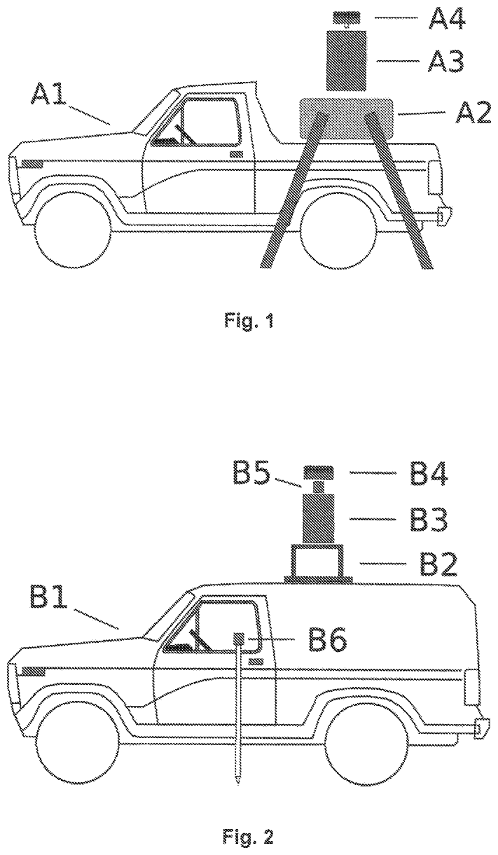

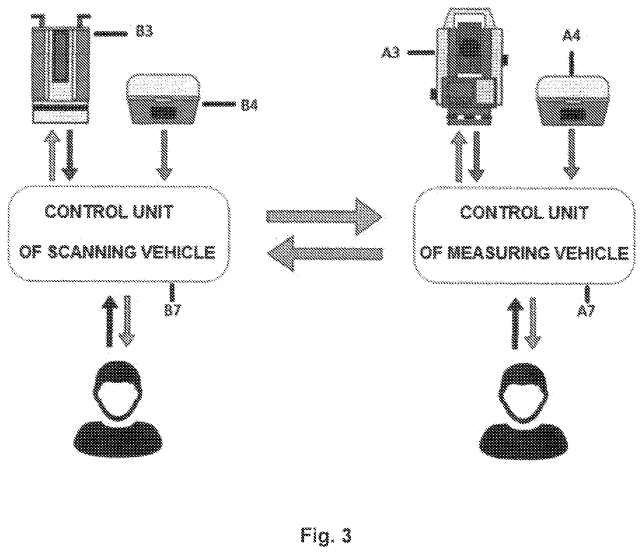

### DESCRIPTION OF EMBODIMENTS

The device consists of two separate units that can be transported on vehicles equipped with a load-bearing platform that allows this device to stand stably and independently if necessary.

One of the components is a measuring vehicle A1 comprising a total station A3, which is a geodetic instrument designed to measure horizontal angle values, elevation angles and distances, which is mounted on a support platform A2. The total station A3 may be controlled by a controller provided by the manufacturer or by software installed on a connected computer. The carrier platform A2 includes a mechanism that allows it to be raised above the measured area when the measuring vehicle A1 passes over it and lowered again when it passes to the next measuring position. This allows the platform to be separated from the structure of the measuring vehicle during measurement, which is important to mitigate movements and vibrations of the A2 carrier platform. A first GNSS receiver A4 is placed above the total station A3 to determine/control its position. The centre of the first GNSS receiver A4 is located in the turning axis of the total station A3.

The second of these assemblies is a scanning transport means B1, comprising, for example, a bracket B2 mounted on a roof rack, on which a laser scanner B3 is mounted, above which a reflecting device B5 for an electro-optical rangefinder is mounted in its vertical axis. The scanning carriage B1 also carries a target device B6 for locating registration points on the measured area, for example a geodetic stake or an its alternative also equipped with a reflecting device for an electro-optical rangefinder. A second GNSS receiver B4 may be mounted above the laser scanner B3 and the survey marker to determine/control the position of these components.

Each vehicle also contains a computer that subsequently controls the connected components described above and guides the vehicle operator through a series of actions that must be performed to properly target the area of interest. The first control unit A7 of the measuring vehicle is used to control the components on the measuring vehicle A1 and to check the measured values by means of individual control blocks. The second control unit B7 of the measuring vehicle B1 is used to control the components on the measuring vehicle B1 and to check the measured values by means of individual control blocks, alerting the operator in the event of an outlying error.

The device measures the surface topography by having the laser scanner B3 mounted on the scanning vehicle B1 scan the surface of the area of interest in a local system in a general position at a sufficient density. The software controlled total station A3 measures, in the required coordinate system, the position of the laser scanner B3, or the reflecting device B5 mounted thereon, and the position of the target device on the means B6 for locating registration points, for example on a stake or its alternative, which is placed by the crew of the scanning vehicle B1 at the locations whose spatial position is to be so determined. Such locations are both features in the terrain used for spatial alignment of point clouds and also stabilized turning points. The software for controlling the total station A3 is arranged to be able to locate the points of prearranged point arrays of known coordinates, which are used to place all the measured values in the desired system. By a point of a point field of a building is meant any positional or elevation point used to provide a geodetic foundation for the building, as well as available points of state geodetic foundations.

During the entire process of spatial data collection, the operator is guided to the next measurement steps according to the expected scenario, the correct spacing of measurement units is monitored, or the measurement steps are performed completely automated.

During the data acquisition process, the equipment performs checks by comparing multiple measured/determined input values or multiple determined positions of a segment of the equipment, such as the position determined by the total station A3 and the position determined by the first GNSS receiver A4, to ensure that no gross error has occurred somewhere in the intermediate step.

Further, the components of the first control unit A7 of the measuring vehicle A1 are described in more detail.

The first control unit A7 contains the control unit for the total station A3, which provides the display of the necessary values of the total station A3 status, e.g. levelling, battery status, telescope camera, and controls the measurement functions according to the required workflow, e.g. rotation, angle and length measurements, using a computer and the corresponding software.

The next block is the block for controlling the first A4 GNSS receiver. This block uses a computer and appropriate software to display the necessary values of the first A4 GNSS receiver status such as GNSS signal quality or battery status, and then controls the measurement functions according to the required workflow such as position in NMEA messages, start and end of measurement.

To facilitate the orientation of the operator of the measuring vehicle A1, the block again ensures, by means of a computer and the corresponding software, that the correct measurement steps are followed, for example, monitoring the spacing from the scanning vehicle B1, the alignment of the total station A3.

The next block checks multiple GNSS position measurements and evaluates outlying measurements.

Since the angles are measured in two faces of the total station A3, the difference of the measured directions or exceeding the limit deviation for their difference is evaluated by the block for checking the angles measured by the total station in two faces.

The forward and reverse height check block checks the difference of the heights determined trigonometrically from the foresight and backsight, or exceeding their limiting difference for both the temporarily stabilized points and the prism heights on the scanner.

Another block checks the difference in height between the prism on the B3 laser scanner and the temporarily stabilized nail and the difference in their distances. This difference is also checked again after the pre-calculated optimization, i.e., after compensating from redundant measurements.

Another block also checks the limit deviation of the multiple measurement point in position and height and the height lock of the program when measuring to a known point.

The second control unit B7 of the measuring vehicle B1 has a block for controlling the laser scanner B3, which, using a computer and the corresponding software, provides display of the necessary values of the laser scanner B3 status, for example, battery status, scan previews, and then controls the measuring functions according to the desired workflow, such as starting a scan, changing the resolution.

The block for controlling the second GNSS B4 receiver by means of a computer and the corresponding software provides the display of the necessary values of the status of the second GNSS B4 receiver, such as GNSS signal quality or battery status, and then controls the measurement functions according to the required workflow, for example, the position in NMEA messages, starting and ending of the measurement.

To facilitate the orientation of the operator of the scanning vehicle B1, the block again ensures, by means of a computer and the corresponding software, that the correct measurement steps are followed, such as monitoring the spacing from the measuring vehicle A1.

The next block checks multiple GNSS position measurements and evaluates outlying measurements.

The following are examples of how to accurately measure the topography of surfaces in civil engineering.

### Example 1

A method of high-precision measurement of the topography of surfaces in civil engineering using two vehicles, namely a measuring vehicle A1 and a scanning vehicle B1. The measuring vehicle A1 carries a carrier platform A2 on which a total station A3 is placed and a GNSS receiver A4, the centre of which lies in the turning axis of the total station. The carrier platform A2 includes a mechanism which allows it to be raised above the ground when the measuring vehicle A1 passes over it and to be lowered again when it passes over the next measuring position. This allows the A2 carrier platform to be separated from the measuring vehicle A1 during the measurement, which is important to mitigate movements and vibrations that would degrade the quality or make measurements by instruments such as total station A3 and GNSS receiver A4 completely impossible. The scanning vehicle B1 has a carrier B2 on which a laser scanner B3 is attached and a GNSS receiver B4 is positioned above it in its vertical axis. The scanning vehicle B1 also includes a target device B6 which is targeted by the total station A3 during the measurement cycle. This target device B6 may be implemented, for example, by a geodetic rod or its alternative equipped with a reflecting device for an electro-optical rangefinder.

An exemplary implementation of a high-precision surface topography measurement method is as follows. The scanning vehicle B1 is positioned at the beginning of the area to be surveyed and the measuring vehicle A1 is positioned in front of the scanning vehicle B1 at a distance corresponding to half the distance of the measurement cycle. The distance of one measurement cycle shall be chosen to be less than 150 metres and the entire measurement section of the measured area shall consist of ‘n’ such cycles, the section shall contain at least one cycle. The start and end of each cycle is defined by a turning point which is stabilised in the measured area, for example by a measuring nail, the end point of one cycle being identical to the start point of the next subsequent measuring cycle and forming the so-called turning points of the trigonometric levelling height line.

The operator of the A1 surveying vehicle shall first survey the points of the construction point field if they are visible from the current position and at a reasonable distance, not exceeding the distance corresponding to half of the measurement cycle, or they may be surveyed during any subsequent position of the A1 surveying vehicle. A point of the construction point field means any positional or elevation point used to provide the geodetic foundations of the construction, as well as available points of the state geodetic foundations. In the process, the operator of the scanning means B1 stabilizes the turning point next to his means of transport and waits for the surveying means A1 to survey it. After or during the surveying of the turning point, the scanning vehicle B1 scans the surface. After these steps, the scanning means B1 moves to the next position where the next surface scan, hereinafter referred to as the scanning position, takes place. The spacing of the scan positions is most commonly chosen to be around 30 metres, but this distance may vary depending on the laser scanner B3 used and the size and shape of the area to be measured. The scanning vehicle B1 also stops during the transitions between scan positions and the vehicle operator attaches a rod or its alternative with a reflective device B6 to the surface of the area to be scanned, which is then measured from the measuring vehicle A1. These points, referred to as registration points, are used for subsequent precise height alignment of the scanned surface. A minimum of one registration point should be located per measurement cycle.

This procedure is repeated until the scanning vehicle B1 overtakes the measuring vehicle A1 and is approximately as far away from it as in the initial alignment, i.e. the measuring vehicle A1 is approximately midway between the scanning vehicle B1 and the previous turning point. At this point, the operator of the scanning vehicle B1 stabilizes the next turning point, which represents the end of the current measurement cycle and the beginning of the new measurement cycle, and forms the so-called imaginary points of the trigonometric leveling line. This turning point is subsequently measured by the measuring vehicle A1. After this step, the measuring vehicle A1 then moves to the next position which is in front of the scanning vehicle B1, in this descriptive example at a distance of 75 m as in the first step. The preceding steps are repeated until the entire assembly reaches the end of the measurement section, where the last turning point of the measurement section is stabilized in the surface of the measured area.

The output of these measurements are the coordinates of the turning points stabilized by the measuring nails, the coordinates of the registration points of the surface of the surveyed area, which are used to align the scanned point clouds, as well as the scanned point clouds, including the coordinates of the individual scan positions, which are determined either by the GNSS receiver B4 or the total station A3.

### Example 2

This exemplary embodiment is similar to Example 1, differing in that the entire measurement section is re-closed to the first turning point by moving the measuring vehicle A1 to the opposite edge of the measured area, e.g. the road, at a distance of 75 m from the last turning point back to the beginning of the measurement section and repeating the process until the first turning point is located. This closes the entire measured section at the same point and it is possible to immediately evaluate the quality of the survey and thus detect possible gross errors, for example by evaluating the height closure at the re-surveyed point.

The advantage is also that the turning and registration points are located on both sides of the measured area, which increases the accuracy of cloud registration in the lateral direction of the target section. Furthermore, the double measurement of the same section also increases the spacing between scan positions.

### Example 3

This exemplary embodiment is based on Example 1, but differs in that a reflecting device B5 for the electro-optical rangefinder is placed between the laser scanner B3 and the GNSS receiver B4. This reflecting device B5 can then be measured by the total station A3 and thus control the measurement of the GNSS receiver B4.

This design is also beneficial in areas with poor satellite signal reception, such as tunnels, around tall buildings, etc., and thus allows determination the position of individual scan positions even without using GNSS measurements.

### Example 4

This exemplary embodiment is based on Example 1, but differs in that the distance of the measurement cycle may be greater than 150 meters, for example 500 meters. This implies that the measurement section will consist of fewer measurement cycles and thus the measurement will be much faster, as it will not be necessary to target so many turning points and so on. At the same time, the spacing between scan positions can be extended. This modification, however, brings with it a reduction in the accuracy of the aiming points, especially their height component, since the accuracy of the measurement decreases with increasing distance between the aiming point and the total station A3.

This modification may be suitable for projects where there is a lower requirement for accuracy, but the emphasis is on speed and efficiency.

### Example 5

This exemplary embodiment is based on Example 1, but with the difference that the target device B6 is suitably adapted to allow continuous targeting, so-called tracking, by the total station A3 even during passes of the scanning vehicle B1 and thus continuous determination of the coordinates of the registration points on the surface of the measured area. By a suitable arrangement it is meant, for example, that the target device B6 is fixed directly to the scanning vehicle B1 and the vertical distance to the measured surface is realized by a laser beam. Or, in a simpler case, a rigid wheel mechanism can be fixed to the bottom of the geodetic aiming device, which allows the aiming device to be in contact with the road even during the crossing.

This advantageous embodiment consists in the fact that the registration points can be measured without time-consuming stopping at a much higher density, practically derived from the maximum measurement frequency of the total station A3.

### Example 6

This exemplary embodiment is based on Example 1, but differs in that the laser scanner component B3 is modified to allow continuous scanning of the measured area, so-called mobile laser scanning, for example equipped with an inertial mobile unit. This makes it possible to scan the surface even during transitions between scan positions and thus increase the number of scanned points on the target area.

### Example 7

This exemplary embodiment is similar to Example 1, differing in that the measuring vehicle A1 is supplemented by a levelling device, which may be either a digital levelling device or a rotary laser levelling device, and a suitably adapted target device B6, which is carried by the scanning vehicle B1 and supplemented by an additional GNSS receiver. For example, the form of the target device B6 may be such that a levelling bar is used and a GNSS receiver is placed on top of the levelling bar. This arrangement makes it possible to target the registration points with a higher height accuracy than when measuring with the total station A3 alone. The position of these registration points is further determined by the aforementioned GNSS receiver A4.

### INDUSTRIAL APPLICABILITY

Geometric quality, i.e. the conformity of the result within the geometric limit deviations set by the project documentation, is one of the parameters that significantly contributes to the final quality of the work. It is an indisputable advantage that geometric quality is precisely defined by the project documentation and therefore clearly demonstrable and verifiable. Moreover, the checking can be carried out absolutely/detailed, and not only selectively, as is usually the case with other quality parameters, and can therefore rightly be regarded as one of the accompanying features of quality assessment. The presented solution can be used to create a digital model of the project and to objectively determine the volume of material, quantity of work, selected items, for example, a report. The solution significantly refines the basis for procurement and quotation calculations, thus minimizing errors and risks of multiple works. A new method of objective evaluation of the quality of contractors and a ranking of contractors can be introduced as one parameter of the evaluation criterion “quality” within the process of contractor selection by the client.

1. A method of accurately measuring the topography of surfaces in civil engineering, wherein ground vehicles equipped with measuring instruments and accessories are used to determine the topography of the area to be surveyed, characterized by the use of two vehicles, namely a scanning vehicle (B1) and a measuring vehicle (A1), wherein the measurement is performed in n repeating measurement cycles, wherein n cycles form the measured section, wherein one measurement cycle is performed as follows, the scanning vehicle (B1) equipped with a GNSS receiver and a laser scanner (B3) stands at the beginning of the measurement section of the measured area and the measuring vehicle (A1) equipped with a GNSS receiver (A4) and a total station (A3) stands on the measured area in front of the scanning vehicle (B1) at a distance of 20 to 250 metres, when the spatial position of the laser scanner (B3) and/or the total station (A3) changes, their spatial positions are determined by the GNSS receiver, then the measuring vehicle (A1) is used by the total station (A3) to measure backsight to the target device (B6), which pinpoints the initial turning point of the measuring cycle, and the scanning vehicle (B1) scans to determine the topography of the measured area, the scanning vehicle (B1) then traverses in successive steps at intervals of 10 to 500 metres between scanning positions, while the scanning vehicle (B1) traverses between scanning positions, the target device (B6) and the total station (A3) measure registration points on the surface of the measured area at maximum intervals of 125 metres, this process being repeated until the scanning vehicle (B1) overtakes the measuring vehicle (A1) by a distance of 20 to 250 metres, where the total station (A3) measure a foresight at the target device (B6) which pinpoints the final turning point of the measuring cycle, after this step the measuring vehicle (A1) moves to the next station which is in front of the scanning vehicle (B1) at a distance of 20 to 250 m and thus the whole one measuring cycle is completed and the measuring cycle is repeated with the next cycle starting with the backsight of the final turning point from the previous measuring cycle, and repeating the measuring cycles until the entire measuring assembly has reached the end of the section of the measured area.

2. The method for accurately measuring topography of surfaces in civil engineering according to claim 1, characterized in that the measured section is closed to an initial turning point of the first measurement cycle of the measured section, such that, by moving the measuring vehicle (A1) between 20 and 250 metres from the final turning point of the last measuring cycle of the measuring section back towards the start of the measuring section and repeating the whole procedure until the initial turning point of the first measuring cycle of the measuring section is measured, to close the whole measuring procedure at the same point and to evaluate the quality of the measurement, in particular by evaluating the height closure, and to ensure a higher density of scanning and registration points.

3. The method for accurately measuring the topography of surfaces in civil engineering according to claim 1, characterized in that the closing of the measured section in a sequence of n cycles is performed without scanning the surface of the area to be surveyed and/or measuring registration points.

4. The method for accurately measuring the topography of surfaces in civil engineering according to claim 1, characterized in that the output of the measurements are registration points and turning points which serve to refine the height measurement of the scanned surface of the surveyed area that was made by the scanner (B3).

5. The method for accurately measuring the topography of surfaces in civil engineering according to claim 1, characterized in that the turning points are stabilized by measuring nails or other similar stabilization.

6. The method for accurately measuring the topography of surfaces in civil engineering according to claim 1, characterized in that the coordinates of the individual scan positions are determined by GNSS receiver measurements and/or total station measurement from the measuring vehicle (A1).

7. The method for precision measurement of surface topography in civil engineering according to claim 1, characterized in that, in addition to registration points and turning points, the total station (A3) of the measuring vehicle (A1) measures the points of the point field for the purpose of accuracy checking, measurement alignment and transformation into coordinate systems other than the coordinate system in which the measurement is performed.

8. The method for accurately measuring the topography of surfaces in civil engineering according to claim 1, characterized in that at least one turning point is replaced by a point of the point field and the foresight and backsight to the replaced turning point is replaced by a foresight and backsight to that point of the point field.

9. The method for accurately measuring the topography of surfaces in civil engineering according to claim 1, characterized in that the scanning of the surface of the surface to be surveyed by the scanner (B3) is carried out during the travel of the scanning vehicle (B1) between the measurement points of the initial turning point and the end turning point of the measurement cycle.

10. An apparatus for high-precision measurement of surface topography in civil engineering comprising a vehicles equipped with measuring instruments and accessories according to claim 1, characterized in that it comprises two ground vehicles, the first of which is a measuring vehicle (A1) with an exposed load compartment, on the hull of which a carrier platform (A2) provided with a mechanism for vertical movement thereof is located, and on the carrier platform (A2) a total station (A3) and a first GNSS receiver (A4) are located, the centre of which lies in the rotational axis of the total station (A3), and where the second ground vehicle is a scanning vehicle (B1) having a roof mount (B2), to which is attached a laser scanner (B3) above which is a reflecting device (B5) for an electro-optical rangefinder and a second GNSS receiver (B4) in its vertical axis, and furthermore a means (B6) for the measurement of the reference points on the measured area, equipped with a reflecting device, is attached to the scanning vehicle (B1), wherein the measuring vehicle (A1) comprises a first control unit (A7) equipped with a program for controlling the components on the measuring vehicle and for continuously checking the measured values against predetermined accuracy criteria, wherein this first control unit (A7) is connected to the output of the first GNSS receiver (A4) and further connected bidirectionally to the total station (A3) and the scanning car (B1) comprises a second control unit (B7) equipped with a program for controlling the individual measuring instruments and for continuously checking the measured values in relation to predetermined accuracy criteria, wherein the second control unit (B7) is connected to the output of the second GNSS receiver (B4) and is further connected bidirectionally to the laser scanner (B3), and at the same time the first control unit (A7) and the second control unit (B7) are connected by their outputs.
